(19) United States
(12) Patent Application Publication
(10) Pub. No.: US 2007/0079243 A1
(43) Pub. Date: Apr. 5, 2007

(54) Monitoring performance of a computer system

(75) Inventors: Andrew Ralph Leigh, Rosanna (AU); Tal Weiss, Surrey Hills (AU)

Correspondence Address: BIRCH STEWART KOLASCH & BIRCH, PO BOX 747, FALLS CHURCH, VA, 22040-0747, US

(73) Assignee: ThirdEye Holdings Pty Ltd

(21) Appl. No.: 11/524,374

(22) Filed: Sep. 21, 2006

Related U.S. Application Data
(60) Provisional application No. 60/719,566, filed on Sep. 23, 2005.

(51) Int. Cl. G06F 15/173

(52) U.S. Cl. 715/736; 709/224

(57) ABSTRACT

A computer program is provided for monitoring the performance or state of a computer system or of an application operable within the computer system or of a computer hardware device in the computer system. The program permits a screen display to be provided of one or more visual components that represent specific system, application or hardware information required to be displayed, as determined by a system administrator, programmer, or like person. The program permits a metric chosen by that person to be assigned to the visual component. This then enables that person or another person such as a user to be provided with a snap shot view of the performance.

### RELATED APPLICATIONS

This application is based on and claims the benefit of the filing date of U.S. Provisional Patent Application Ser. No. 60/719566 filed 23 Sep. 2005 the contents of which are incorporated herein by reference.

### FIELD OF THE INVENTION

This invention relates to monitoring the performance or the state of a computer system or of an application associated with the computer system or of a hardware device associated with the computer system. The invention has particular although not exclusive application for use by administrators who monitor the performance or state of computer systems or applications or hardware devices therein.

### BACKGROUND ART

There have been prior proposals for programs for monitoring the performance of computer systems or of applications operable within the computer systems or of hardware devices. Such proposals have used programs that have been designed on a generic basis with predefined screen displays and with predefined metrics associated with individual systems or applications or hardware devices in mind. The prior programs have been “fixed” in the sense that a person administrating the system is unable to customise the particular screen layouts and/or associate particular metrics with system components being monitored. As a consequence of this, a person administering a system has limited ability to readily assess those particular system components or applications or hardware devices that may be causing bottlenecks or problems in a particular environment. In other words, in the known systems a person may need to browse through multiple fixed screens in order to diagnose system problems.

The present invention has been devised to provide for monitoring performance of a computer system or an application operable within the computer system or of a computer hardware device by allowing customising of various screen displays, and enabling chosen visual components to appear on those screen displays, and to enable chosen metrics to be associated with the chosen visual components. In this way, a user such as an administrator can customise one or more screens to provide monitoring information in a snapshot view that indicates performance criteria of interest to the administrator.

### STATEMENT OF INVENTION

According to one broad aspect of the invention there is provided

A computer program for monitoring the performance or state of a computer system or of an application operable within said computer system or of a computer hardware device in a computer system,

the computer program comprising software configured to permit a screen display of one or more visual components representing specific system, application, or hardware device information chosen by an administrator, programmer or like person,

said software having processing that permits the assigning of a metric chosen by the administrator, programmer or like person to a visual component provided on the screen display,

thereby providing a user with a diagnostic snapshot view of the performance or state of one or more computer systems or of one or more applications or of one or more hardware devices.

Preferably, the software enables a chosen visual component to be provided in a customized position of a screen display.

Preferably, the software enables the scale and/or height and/or width of a chosen visual component of a screen display to be customised.

Preferably, the software enables available metrics to be provided from a drop-down menu or a palette and wherein an administrator can apply a chosen metric to a visual component by selecting a particular metric from the drop-down menu or palette.

### BRIEF DESCRIPTION OF THE DRAWINGS

In order that the invention can be more clearly ascertained an example of a preferred embodiment will now be described with reference to the accompanying drawings wherein:

FIG. 1 is a block schematic diagram showing an overview of basic software interrelationship of an example of the preferred embodiment.

FIG. 2 is a diagram showing various visual components that can be selected by an administrator or other person for particular screens.

FIG. 3 is a screen display showing a pre-assigned set of visual components and metrics for those visual components concerning a basic system.

FIG. 4 is a screen display showing creation of a particular customised screen display.

FIG. 5 is a screen display dialog showing an interface that enables an administrator to select one or more metrics for particular visual components.

FIG. 6 is a view similar to that shown in FIG. 5 but showing how various alarms can be associated/configured with particular metrics.

FIG. 7 is also a view similar to that shown in FIGS. 5 & 6 but showing how various attributes of the metrics can be altered.

FIG. 8 is a functional block diagram showing process steps involved in assigning a metric to a visual component.

FIG. 9 is a functional flow diagram showing process steps for metric refreshing.

FIG. 10 is a diagram showing how a visual component is automatically split, if there are multiple instances that cannot be shown by a single visual component,

FIG. 11 is a view of an object used at a node of a tree structure to indicate if there is an alarm condition within a node and in any child nodes in a hierarchical tree structure,

FIG. 12 is a block schematic view showing interconnection of a computer system to a remote hardware device.

FIG. 13 is a functional flow diagram showing a topology drill down feature for multiple computer systems, and

FIGS. 14a-14f are screen displays showing drill down possibilities in a monitored environment that includes multiple computer systems

### DETAILED DESCRIPTION OF PREFERRED EMBODIMENT

The example of the preferred embodiment provides for visual monitoring and diagnostic assessment of a computer operating system or applications operable within the computer system or of computer hardware devices. The example incorporates a plug-in style architecture that allows monitoring of different systems and services simultaneously inside an application. The example enables users to view real-time performance, historic data, configure alarms, design visual layouts, generate reports and develop custom data collectors. The example enables snapshot views of the performance of a computer system or of an application or of hardware to be determined so that the health of the system can be readily ascertained.

The example includes a console part and a packages part. The console part is the application shell that provides a user interface to a visual display on a computer monitor screen. The console processes the visual display and handles all display functions except specifics about systems that are to be monitored. The package parts are plug-ins that install into the console. The packages are responsible for data collection from the system and contain functionality and visual screen layout information. The packages, in turn, collect data from datasources that are associated with the packages. Different packages can share the same datasources and when a package is installed the datasources that it uses are installed concurrently. When a datasource is installed, datasets are also installed with the datasource.

A metric is a single piece of data, showing information retrieved from a monitored system. A metric can be numeric or textural. If a metric shows information that corresponds to multiple items in the computer system, then these items are called “instances”. For example, a metric named “disk used gigabytes” will show the number of gigabytes left on a logical disk. If the system has two disks, the instances for this metric might be “C”, and “D”. The items in the computer system are then identified by visual components. These are graphical objects that show various visual depictions of the computer system or application or hardware devices. Visual components include, but are not limited to, charts, tables, spinners, text, lists, gauges, labels, and panels. Some of these visual components may be motion graphics such as a spinner. An administrator or like person can create their own visual monitoring screen(s) by selecting the desired visual components.

Visual components are graphical representations of system metric(s) linked to one or more logical units of a system and/or application and/or hardware device. A visual component has a number of configured attributes, some of which are visual and can be used for monitoring and diagnostic purposes.

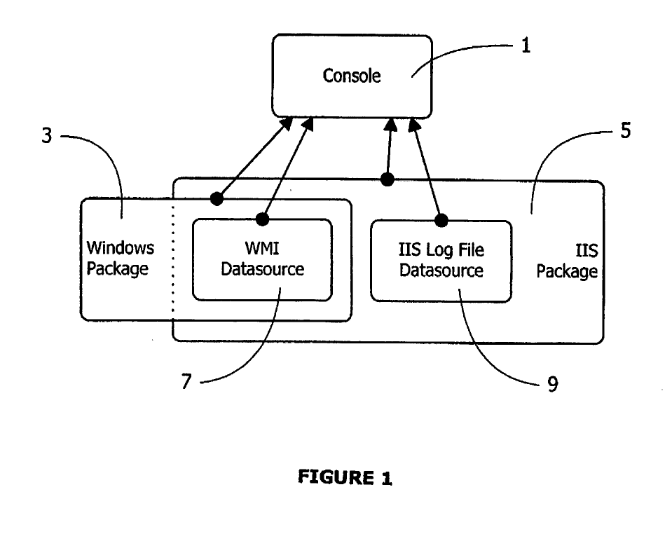

Referring now to FIG. 1, there is shown an overview of the software interrelationship. The software has a plug-in based architecture that allows it to monitor software and hardware of different systems simultaneously inside one application. The physical structure of the software is made up of a console application, packages and datasources. The “console” is the application that enables the user to interface to a visual screen display. The console functions to process data about the system to be monitored but knows nothing about underlying interconnections or how data is retrieved from the system(s). FIG. 1 shows the console application and examples of different types of datasources that collect information about the system(s) and the metrics from the installed packages to be obtained. Datasources can be thought of as data collectors and are installed at the time when the package they are used with is installed. Multiple packages can share the same datasources if required. In FIG. 1, the console 1 is connected with two packages being a Windows package 3, and an IIS package 5. Here, there is provided, as an example of datasources, a WMI datasource 7, and an IIS log file datasource 9. The Windows package 3 utilises the WMI datasource 7, and the IIS package 5 utilises the WMI datasource 7 and the IIS log file datasource 9. This example shows that the packages 3 and 5 can share datasources such as datasources 7 and 9 with each other. Once a package and its datasources are plugged into the console 1, an administrator, programmer or other like person can use this package to connect to multiple systems. For example, a Windows package is used to connect to Windows Servers A and B and the software creates two separate Windows “connections”. One connection is to Server A and the other is to Server B. A connection is therefore an active link to the systems, software or hardware to be monitored.

Accordingly, FIG. 1 shows how the example utilises a console for the purposes of displaying information on the monitor screen used by the administrator, programmer or the other like person, and also shows how the underlying information of the computer system(s) application or hardware can be connected using various datasources within particular operating system packages or other like packages.

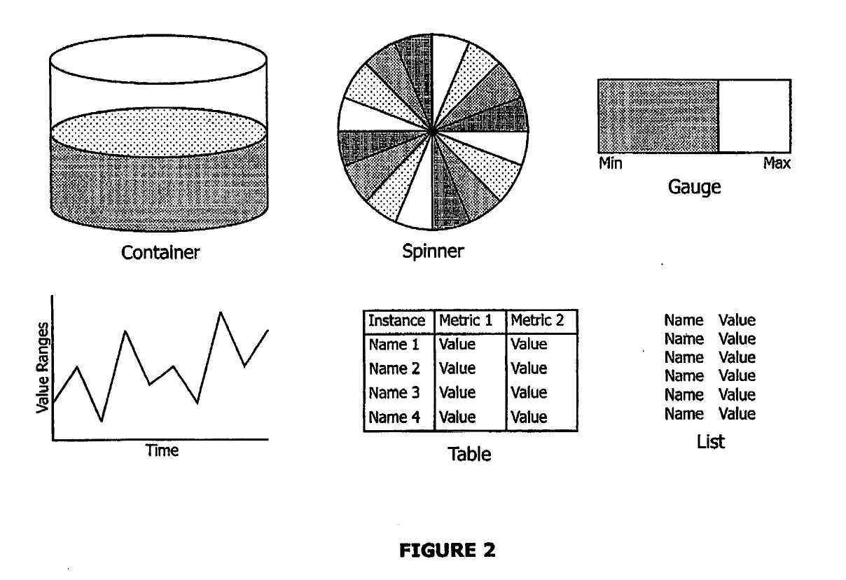

FIG. 2 shows an example of particular visual components utilised in the preferred example. Here, one visual component comprises a container, another a spinner, another a gauge, another a chart, another a table, another a list. Text may also be available as a visual component. Further, a panel may be provided as a visual component in which information can be presented. All of these visual components are graphical objects that can be selected for configuring a customised visual monitoring system.

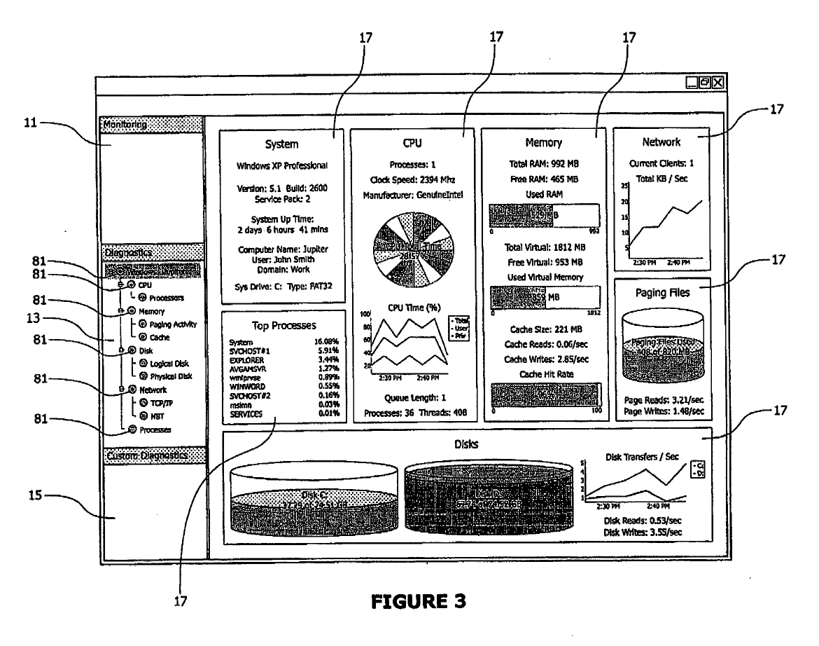

FIG. 3 shows a typical screen display of the example operating on a computer system running Windows. The example is not limited to operation in a Windows system environment and can operate in any system environment. A Windows environment has been chosen for illustrative purposes only. Here, FIG. 3 shows a typical screen display that is pre-customised with the computer program used for monitoring purposes. This computer screen is displayed by the console 1 and has the underlying Windows package 3 installed into the console, and obtains data from the system using the WMI datasource 7.

The program of the preferred example provides three different monitoring layers that are all integrated. These three layers are shown visually on the left hand side of FIG. 3 as three tree control panels being monitoring panel 11, diagnostics panel 13, and custom diagnostics panel 15. The monitoring panel 11 is used as a “topology view” management area where graphical objects that represent different monitoring systems or connections and custom pages sets can be organised. This will be explained in due course.

The diagnostics layer 13 is used to view screens that are pre-prepared in the computer program and which graphically depict visual components and metrics of a single connection.

The custom diagnostics panel 15 is used to enable an administrator or like person to design customised screens using selected visual components and selected metrics.

The visual components shown on the right hand side of FIG. 3 (being the largest part of the screen view) have been set in the computer program at the time of delivery to a customer. The screen display shown in FIG. 3 is representing a screen display for the diagnostics layer 13, and it can be seen that it includes a number of visual components that comprise panels and other visual components. The panels are identified by numerals 17. Some of the panels 17 include information about the system, and other panels include visual components in the form of spinners or gauges or containers or charts to indicate particular values of the metrics that are assigned to particular visual components.

FIG. 3 shows that within the diagnostics panel 13 there is a tree structure of the particular system being monitored. The screens that are displayed on the monitor are negotiated by clicking on a tree node. The diagnostic panel 13 typically shows the parent level of the tree structure and by clicking on particular nodes, one can drill-down through various child nodes to obtain more detailed information about the system. Thus, in FIG. 3, it can be considered that the screen displays in the diagnostic panel 13 are read-only and cannot be customised in any way.

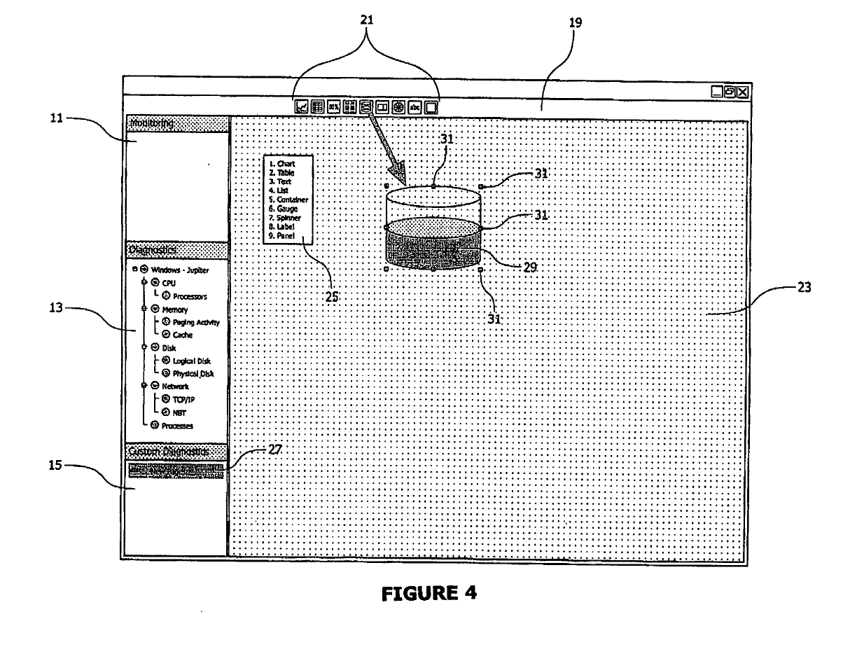

In order to enable particular screens to be customised/designed by an administrator, programmer or like person, that person can click on the custom diagnostics panel 15, to open a blank screen. This is shown in FIG. 4. Here, the screen displays a header part 19 that shows a palette 21 with available visual components. It also shows a grid 23 applied across the bulk of the screen display. User selectable options may be provided to enable the grids size to be changed. The grid provides snapable point locations for fixing selected visual components at particular positions in the screen display. FIG. 4 also shows a drop-down bin 25 that lists nine possible visual components. These are representative only and other numbers and types of visual components may be displayed in the bin. It is noted that the palette 21 has graphical indications of the particular visual components whereas, in the example shown, the drop down bin 25 only lists the visual components. If desired, the drop-down bin 25 may either independently show only the available visual components in the same way as they are shown in the palette 21, or alternatively it may show a listing of the available visual components together with a visual indication as shown in the palette 21. The diagnostic panel 15 shows a sub heading 27 entitled “New Page”. By right clicking the sub heading 27, the user can rename a sub heading. The user then progresses to customise/design the screen layout by adding particular visual components either from the drop-down bin 25 or from the palette 21. These particular visual components have been generalised in FIG. 4 by showing only a single visual component 29 being a container. FIG. 4 shows that the container is bounded by size and scale changing points 31. The user can click on a particular point 31 to change the size and scale of the chosen visual component 29 by then dragging the point to a required position. Further, a chosen visual component 29 can be clicked with the mouse and moved to any desired position on the screen display, and can be snap-locked to one of the grid positions in the grid 23. Thus, a user can create and customise particular screen displays using chosen visual components. The user can also customise the scale and/or height and/or width of the chosen visual component 29. It can also be seen that once a particular visual component 29 has been selected, either from the drop-down bin 25 or the palette 21, it can be dragged-and-dropped to the screen display. Once the screen layout has been completed with the required visual components 29, particular metrics can be assigned to the chosen visual components 29.

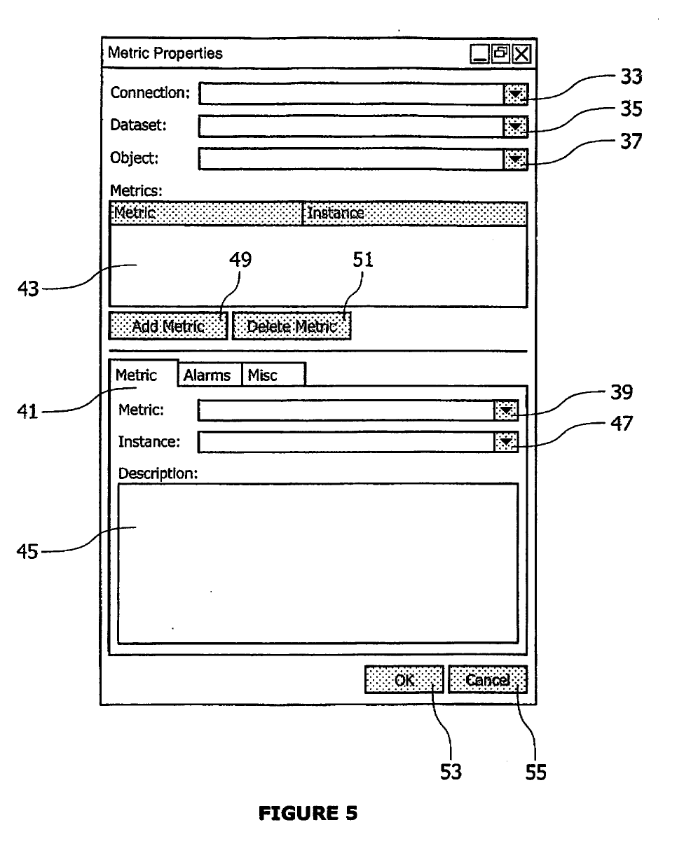

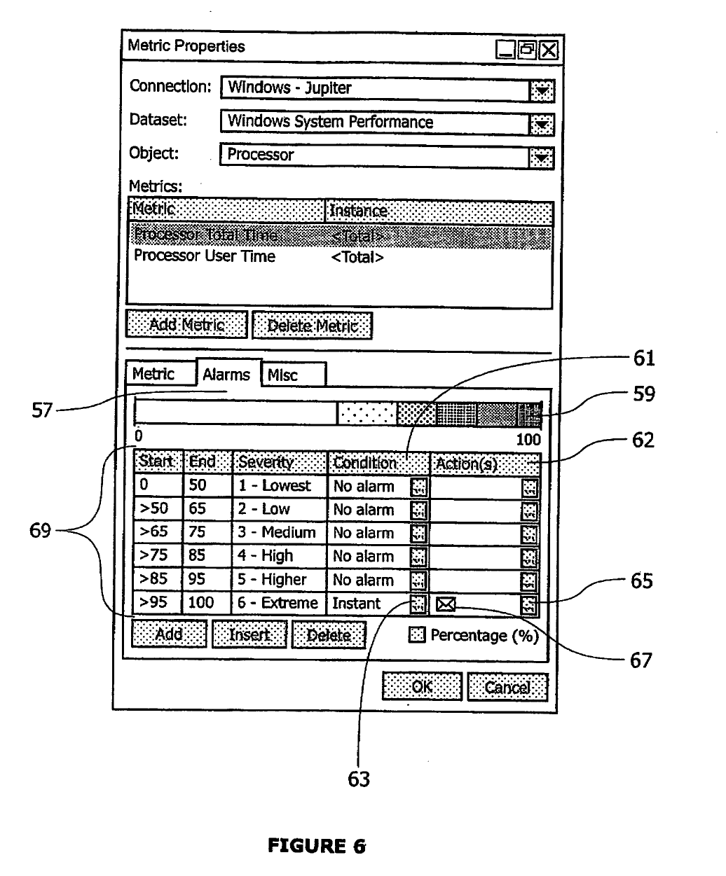

FIGS. 5 and 6 show how particular metrics can be applied. Here, one of the visual components 29 is right clicked with the mouse and this opens up a dialog window as shown in FIG. 5. This dialog window enables the user to associate a system metric to a visual component 29. Once associated to a system metric, the visual component 29 can display values of metrics. It should be noted that some visual components 29 do not need to be linked to metrics and are only used for visual purposes. These types of visual components 29 are, for example, objects like panels and labels.

The screen shown in FIG. 5 is the metric properties dialog window. An administrator, programmer or like person configures a metric for a chosen visual component 29 by first selecting a “connection”. By clicking the drop-down button 33, one is able to select any currently active connection of the monitored system(s). Next, one clicks button 35 to enable a “dataset” to be selected from the drop-down dataset control. A “dataset” is a grouping of objects. Different objects will be available in the “object” drop-down control entered by clicking button 37. The “dataset” type selected will determine the different objects that can be available from the “object” drop-down control accessed when clicking button 37. The “objects” available are associated with the subject of a selected dataset. Once an object has been selected, the user must add a new metric to the metric list control 43 by clicking the Add Metric button 49. This newly added metric will be shown as “undefined”. The user then moves to define this particular metric by clicking button 39. It is noted in FIG. 5 that the metric tab 41 is open. Thus, by clicking on the particular button 39 a metric name can be associated with the chosen metric in the metric list 43. Once button 39 is clicked, this lists the available metrics in the object. A user then clicks a particular metric listed and the chosen metric is replicated into the selected metric of the metric list display region 43. It is noted that a description panel 45 is provided to provide an explanation of the particular metric that is clicked. This gives the user an indication of the nature of the clicked metric. The user can then click button 47 to display a drop-down menu of available instances, if any. Here, the user can select “all instances” of the particular object that appear in the system or single instances. For example, if the visual component 29 is representing a hard disk, a user has an option to select all instances of hard disks in the system or a particular hard disk in the system. If the user is adding an instance to a visual component 29 such as a container, or a gauge, that cannot physically display more than one instance values, then the particular visual component is split to show the required multiple visual components for the instances. This will be explained later.

Multiple metrics can be applied to particular visual components 29. In the process of adding multiple metrics, the user clicks the Add Metric button 49. This permits the user to then again click button 39 to show further metrics that can be applied. If a particular metric is to be deleted then the user can click the Delete Metric button 51.

Once the user has assigned particular metrics to a visual component 29, the user can click the OK button 53 and the system then initialises with the chosen metric(s) and reverts to displaying the current value of the metric(s) for the chosen visual component 29. If the user clicks the Cancel button 55 then all the newly assigned metrics and instances for the particular visual component 29 will be lost and the visual component will revert back to the state it was in before the Metric Properties dialog was opened.

FIG. 6 shows a dialog window layout for metric alarm settings. Here it can be seen that it is similar to the screen shown in FIG. 5, but here, the alarm tab 57 is active. The alarm tab 57 is made active by the user simply clicking the tab 57. Here, alarms can be set for each of the chosen metrics. In the example shown there are six levels of alarm thresholds. These are represented in the description table 69. Here level 1 represents the lowest severity for which an alarm can be created whereas level 6 represents the highest or most extreme level. A color severity threshold gauge 59 is also provided to indicate a visual display of the severity thresholds. The colors, range from green to red. Thus, severity 1 can be represented by a green color where as severity 6 can be represented by a red color. The colors of the severities are then linked to the visual component 29. If a metric's value is within the threshold ranges configured, then the color of the metric's visual component (or part of the visual component) will change to that color. This gives a viewer immediate feedback regarding the severity of the metric linked to the visual component 29. The alarms table 69 has an Actions vertical column 62 against each of the particular severity levels to indicate whether a condition 61 can trigger an alarm or not. Each severity level has a configuration button shown generally by button 63 that enables a user to select “no alarm”, or “time based alarm”, or “instant alarm”. Each of the severity levels has a button 65 that can open a configuration dialog to allow an actions list to be compiled for each of the respective severity levels. Thus, for example, at the extreme severity level shown by level 6, a user can click button 65 which will open a configuration dialog to enable a particular action to be initiated. In this case, an email logo 67 has been shown indicating that an email will be sent if the visual component 29 metric reaches severity level 6. This email message can be tailored to be sent to a system administrator or an assistant of the administrator or the like. The actions may include, but are not limited to, sending an e-mail, executing a script or an application, or displaying a pop-up message on the current screen display.

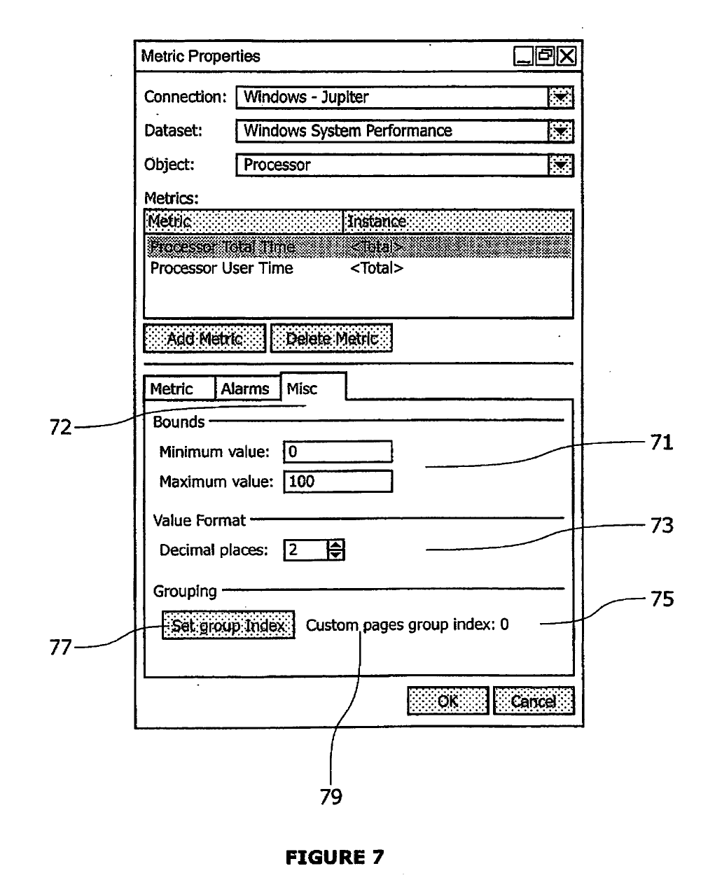

FIG. 7 shows a dialog window layout where the miscellaneous tab 72 is open. This tab includes various configuration options. The Bounds section 71 allows the administrator to alter the minimum and/or maximum values for the selected metric. The Value Format section 73 simply allows the administrator to alter the number of decimal places that the metric value shows. The Group section 75 allows the administrator to set a group index on the selected metric. A group index is a unique number that is assigned to the metric. This number is then used to link other metrics together which will allow the grouped metrics to share the same properties amongst each other. This is known as “tagging”. Changing a property of a metric that is tagged by a grouped index will cause the same change to the other metrics that are tagged by the same group index number. A group index number can be assigned to a metric by pressing button “Set group index” 77. The user is then able to enter a number that will tag the metric. The selected number will then be displayed in the label 79.

The user can build as many diagnostics screens as required, using as many tree nodes, as desired. The user can build these screens by right clicking in the custom diagnostics panel 15 and a new page heading 27 will be displayed. A blank screen will then appear. The process described above can be repeated for each newly created screen.

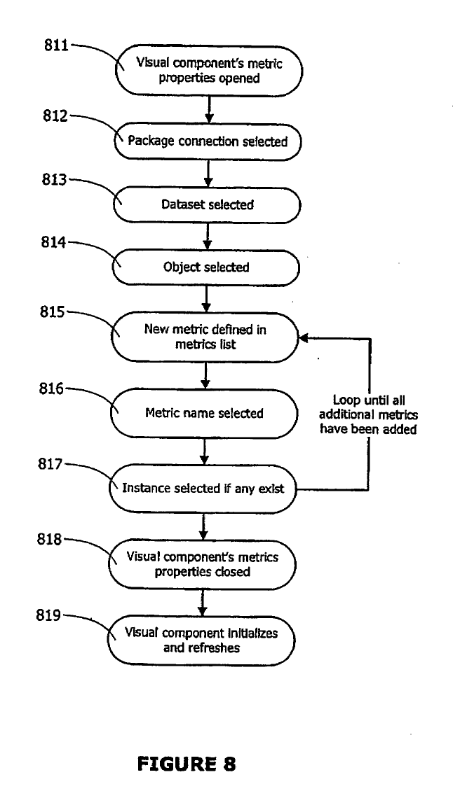

Referring now to FIG. 8 there is shown a functional flow diagram of how a particular metric can be assigned to a visual component 29. Here, at step 811, the particular metric properties for the chosen visual component screen shown in FIG. 5 is opened. At step 812 the particular connection is selected by clicking button 33. At step 813 a particular dataset is selected by clicking on button 35. At step 814, a particular object is selected by clicking button 37. At step 815 a new metric is added to the metrics list 43 by clicking on Add Metric button 49. Step 816 is where the actual metric is selected. Step 817 is where an instance is selected by clicking button 47. Step 817 has the option to loop back to step 815 to add additional metrics. Step 818 occurs when the OK button 53 is clicked and this, in turn, initialises step 819 to refresh the metrics for the visual component as selected.

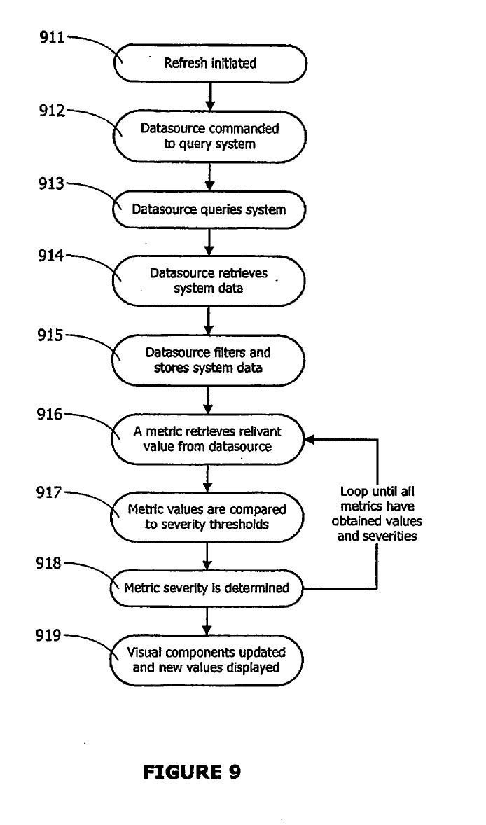

FIG. 9 shows a functional flow diagram associated with refreshing of metrics. The refreshing rate can be selected to a particular time value as required by an administrator. At step 911 the refresh is initiated. At step 912 the particular datasource 7/9 in this example, is caused to query the system. At step 913 the datasource queries the system. At step 914 the datasource retrieves relevant data from the system. At step 915 the datasource sources and stores the retrieved system data and filters out any unwanted information. At step 916 a metric from the console retrieves relevant values from the datasource 7/9. At step 917 the metric values are compared to the severity thresholds set in the alarm section shown in FIG. 6. At step 918 the severity is determined. A loop is implemented at step 918 to return to step 916 until all metrics have obtained values and severities. At step 919 there is an updating of the displayed values of the metrics and the visual components and the severity level displays and/or actions.

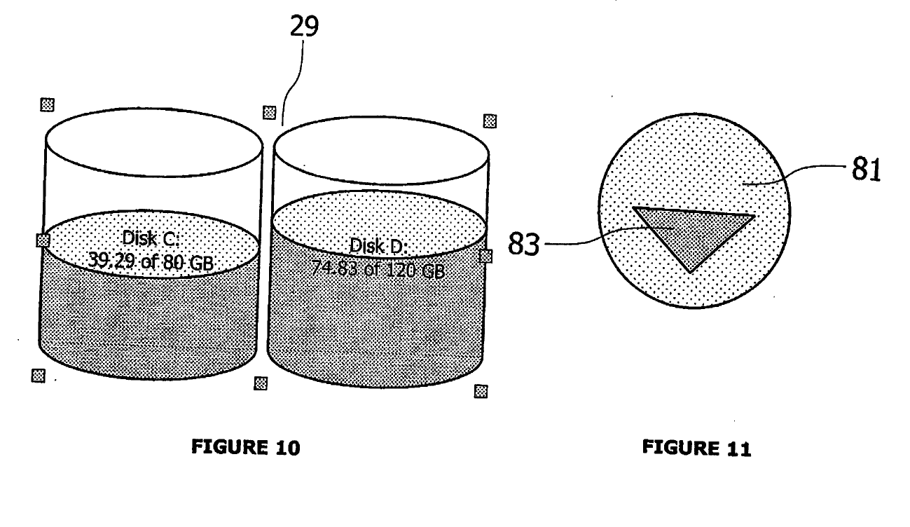

Referring now to FIG. 10, there is shown how visual components 29 can be automatically split into multiple displays, if the user selects “all instances” from the drop-down menu by clicking button 47 as shown in FIG. 5. This is for a case where the particular visual component 29 is a visual component such as a container or gauge that cannot physically display more than one metric value. Here, multiple metric values are shown but broken down to the particular instances in the computer system such as disk C or disk D. FIG. 10 shows that disk C has 39.29 gigabytes of an 80 gigabytes disk used and that disk D has 74.83 gigabytes of a 120 gigabytes disk used.

The administrator, programmer or like person can build as many customised diagnostics screens using as many tree nodes as they wish. Each node in the tree contains a small circular object 81 shown in FIG. 11. The object 81 visually depicts the current state of health of a visual component on the screen. In this example the most unhealthy visual component in a screen of a particular node and child nodes is displayable. This object 81 is shown in FIG. 3 against each of the nodes. The object 81 is able to change color according to the severity color of the unhealthiest metric (or the metric with the value within the threshold of the highest severity) in a visual component shown on the current screen. This can tell a user that a metric and a visual component somewhere on the current screen is in a particular severity rating threshold. FIG. 11 shows a small downward facing triangle 83. This downward facing triangle 83 indicates to a user that they may need to bury deeper into the tree to find an offending metric. If a tree node does not carry any child nodes, then the small colored triangle 83 will not be displayed. The small downwardly facing triangle 83 is colored in the same color as the severity level of the least healthiest metric within any screen of a child node. Further, the downwardly facing triangle 83 may be arranged to blink or flash at an alarm condition rate to signify that a user needs to bury down to a lower level in the tree structure.

When one creates/designs multiple pages by entering the custom diagnostics panel 15, the software has a facility to enable one to copy and paste particular visual components 29 from one screen to another screen. This will aid speed in creation of multiple screens. Any assigned metrics can be optionally arranged to transfer from one screen to the other screen with the particular visual component 29. Alternatively, any assigned metrics may be replaced after the transfer process so that when the visual components are applied to a new screen, it will be necessary to assign particular metrics to that visual component.

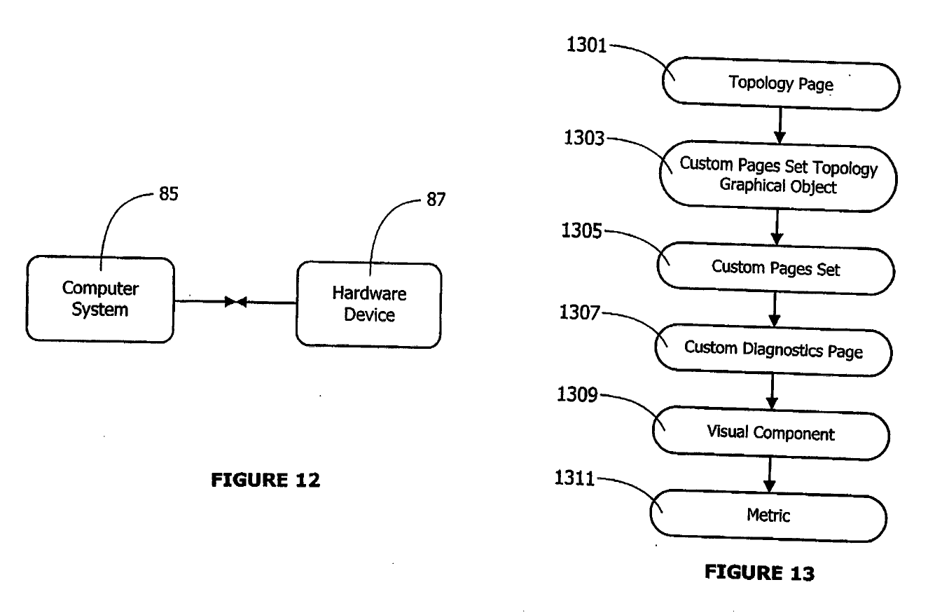

Referring now to FIG. 12 there is shown how the software has the ability to transcend a local computer system and enable monitoring of the performance or state of a remote computer system or hardware device. FIG. 12 shows a local computer system 85 and a remote hardware device 87. The remote hardware device may be a device in a network and may comprise a shared printer, a router, or other hardware device. Thus, the system software is able to enable a screen display to be provided depicting a visual component of the remote hardware device 87 and have metrics associated with any remote hardware devices 87.

The software has the ability to link customised diagnostic screen displays with a topology layout. This enables one to have full flexibility of being able to design and build a complete hierarchy of an organisation and systems within it. With such an arrangement, an administrator, programmer or like person can browse from a very high topological layout (for example a country) down to an extremely low technical level (for example metrics of a particular visual component). In such an arrangement, an administrator clicks on the monitoring panel 11 with the right mouse button. This opens a new blank screen on which the administrator, programmer or like person can apply particular chosen visual components. The visual components can be placed on, for example, a map of the country where multiple computer systems are employed. The administrator, programmer or like person is able to apply further visual components to the map to indicate, for example, cities or states of the country. Each of these cities or states can then be represented by further visual components indicating specific sites where computer systems or hardware devices exist. This gives one the ability to be able to design and build a complete hierarchy of an organisation and all the systems within it. The administrator, programmer or the like person can build custom pages sets within panel 15. A custom pages set, as a whole, can be represented by particular graphical objects (visual components), within the topology views and placed into a customised topology screen display. The graphical objects used in the topology view can be arranged to have a health severity color applied to give a visual indication of the health of the least healthy metric in the entire custom pages set. Thus, with this arrangement, one is able to build a set of customised diagnostic screens that show the health of important components within systems throughout, for example, a country. The arrangement will provide one with an intuitive way to drill down from a topology view into particular customised diagnostic screens.

FIG. 13 shows a functional flow diagram depicting this arrangement. Here, the uppermost topology page 1301 is shown. An administrator, programmer or like person can then drill down from the topology page to a custom pages set topology graphical object (visual component) at 1303. From the custom pages set topology graphical object 1303, the administrator or like person can drill down to a custom pages set 1305. The administrator, programmer or like person can then drill down from the custom pages set 1305 to a custom diagnostics page 1307. The administrator, programmer or like person can then drill down from the custom diagnostics page 1307 to a visual component 1309. The administrator, programmer or like person can then drill further down to show a metric 1311 of a particular visual component shown at 1309.

It can therefore be seen that the above processing enables one to link customised diagnostics screens with a topology screen arrangement.

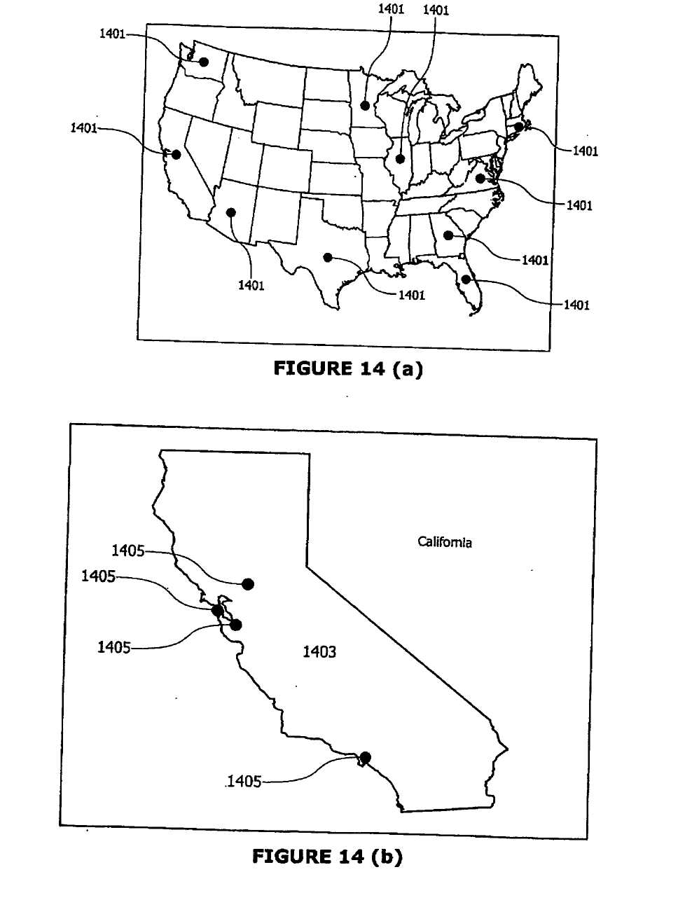

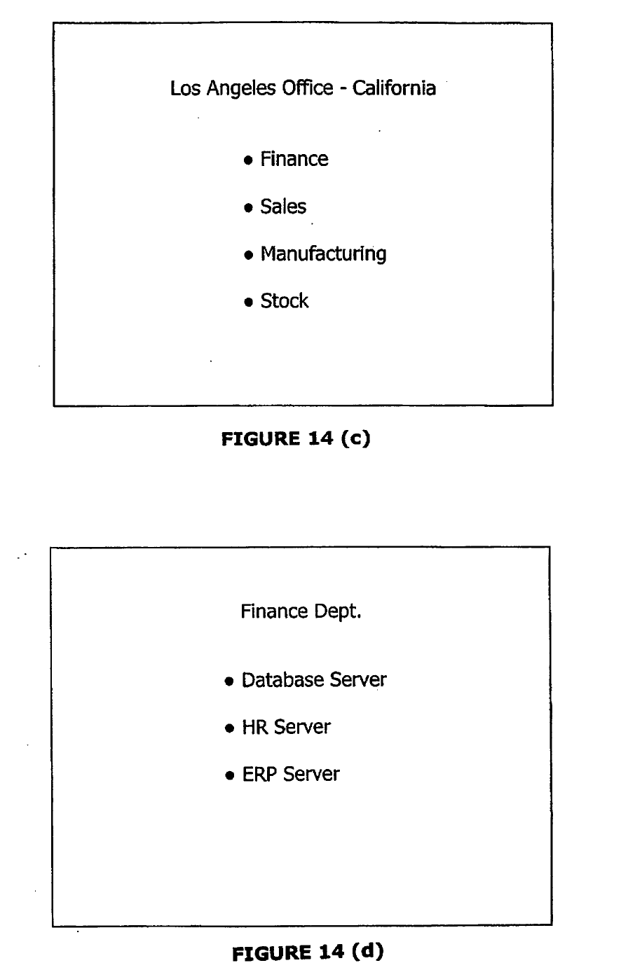

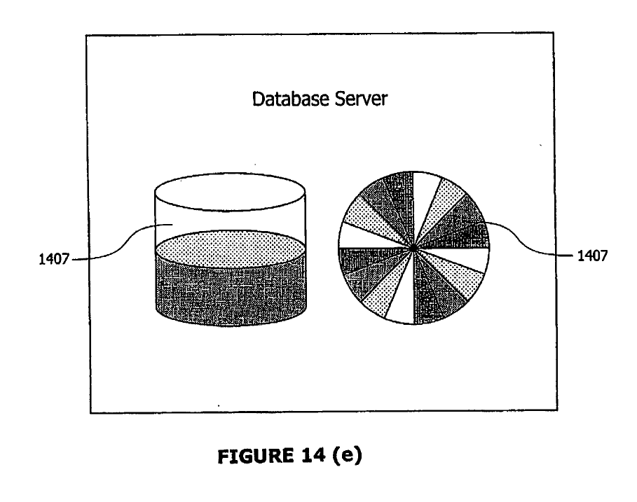

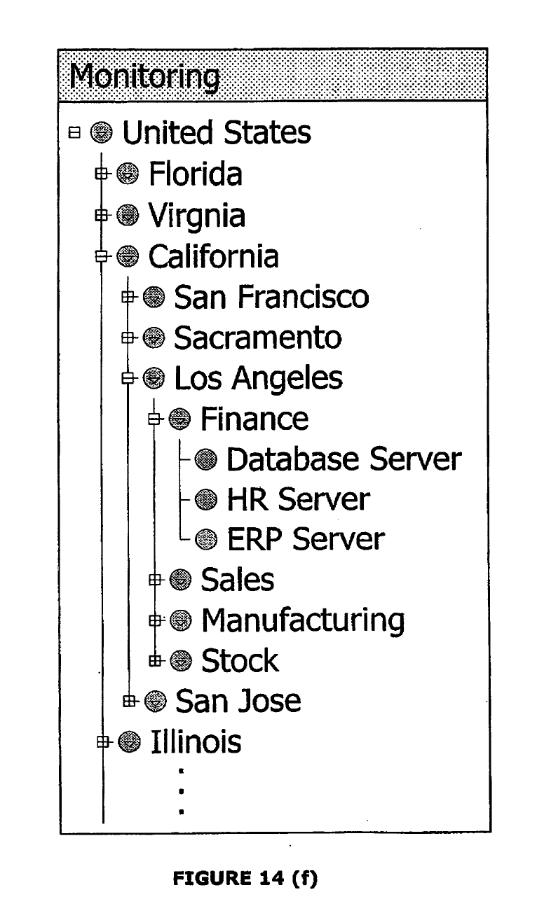

FIG. 14a graphically depicts a map of USA and its states. Thus, it can be seen that an administrator can provide a screen display showing a map of USA with particular cities or states highlighted with further visual objects 1401. FIG. 14b shows how a further screen display has been created when clicking a particular one of the visual components 1401. Here, a state of USA 1403 is shown with particular further visual objects 1405 depicting sites where computer system installations are provided. Particular names can be provided (not shown) underneath the particular visual components 1405 to identify the particular computer system. FIG. 14c shows that one of the sites 1405 has been drilled down to a further page which indicates a main office. Here, the screen display on that page shows particular departments at the main office. FIG. 14d shows a further screen when one of the departments in the main office is clicked. Here, a Database server, a HR server and a ERP server are shown. FIG. 14e shows how if the Database server shown in FIG. 14d is clicked how further visual objects 1407 are depicted on that screen display. Particular metrics will have been assigned by the administrator, programmer or like person to show metrics associated with the visual components 1407.

FIG. 14f shows the hierarchical tree structure that would subsequently appear in the monitoring panel 11.

The above process depicts how one can create multiple topology views that permit drilling down to particular diagnostic pages.

Many variations can be made to the examples described above without departing from the ambit of the invention. For example, the header section 19 (see FIG. 4) may include various buttons to enable drop-down menus for various functions to be implemented when creating and designing a particular screen.

Further, the computer program itself may be used by development personnel to build particular packages that contain predefined screen layouts. In other words, the basic software program may be used by developers to develop a bespoke diagnostic system for any system. In that event, the developers would deliver a final product to the customer and the customer would have no control over altering the predefined (read only) screen displays. The user however will be able to create additional custom screens based on the metrics in the developed package. It can therefore be seen that the example enables itself to operate in four possible modes being:
i. Detailed diagnostic development page mode customised by a particular administrator, programmer or the like person;
ii. Diagnostic viewing mode of developed pages;
iii. Monitoring and grouping mode of particular connections;
iv. Developers' tools mode for creating bespoke monitoring software for particular customers and systems.

In a variation, the system may be used to locally or remotely monitor an external environment, such as a safe in a bank. In this case, a visual component can be assigned to a screen display to provide a graphic indication of the safe. The bank's computer system used for monitoring the safe will then enable a metric to be assigned to the visual component indicating a state of, for example, a safe door—such as “closed” or “open”. Appropriate alarms, or scripts can be assigned to the metric(s) chosen so that, for example, if the safe is “open” an alarm or script can be activated thereby providing an alarm action.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the art forms a part of the common general knowledge.

These and other modifications may be made without departing from the invention, the nature of which is to be determined from the foregoing description and the appended claims.

1. A computer program for monitoring the performance or state of a computer system or of an application operable within said computer system or of a computer hardware device in a computer system,
the computer program comprising software configured to permit a screen display of one or more visual components representing specific system, application, or hardware device information chosen by an administrator, programmer or like person,
said software having processing that permits the assigning of a metric chosen by the administrator, programmer or like person to a visual component provided on the screen display,
thereby providing a user with a diagnostic snapshot view of the performance or state of one or more computer systems or of one or more applications or of one or more hardware devices.

2. The program of claim 1 further comprising software for enabling an administrator, programmer or like person to position a chosen visual component in a customized position of a screen display.

3. A program of claim 2 further comprising software for enabling an administrator, programmer or like person to customize the scale and/or height and/or width of a chosen visual component of a screen display.

4. A program as claimed in claim 2 comprising software wherein available visual components are selectable from a bin or palette and wherein a visual component can be selected therefrom and applied to a screen display by the administrator, programmer or like person.

5. A program as claimed in claim 4 comprising software to allow an administrator, programmer or like person to select a visual component from said bin or palette and drag-and-drop said visual component to said screen display as a chosen visual component.

6. A program as claimed in claim 1 comprising software wherein available metrics are displayable in a drop-down menu or in a palette or in a list and wherein an administrator, programmer or like person can assign a chosen metric to a visual component by selecting a particular metric from the drop-down menu or the palette or a list.

7. A program as claimed in claim 2 further comprising a snapable grid to align a chosen visual component at a snapable position of the snapable grid.

8. A program as claimed in claim 1 further comprising software for enabling a screen display to be a node of a customizable tree structure and to enable an administrator, programmer or like person to create multiple screens of multiple nodes, and to build a hierarchy of screen displays to represent the logical structure of a monitored environment.

9. A program as claimed in claim 1 further comprising software for enabling the health of a metric of a visual component to be shown on a current screen display.

10. A program as claimed in claim 1 further comprising software for drawing attention to a least healthy metric shown on a screen display by modifying a visual depiction of the visual component based on a health severity threshold of the metric.

11. A program as claimed in claim 8 further comprising software for enabling an administrator, programmer or like person to map multiple systems into a customizable screen and to use the customizable tree structure to permit drilling down from mapped multiple systems to individual systems.

12. A program as claimed in claim 1 comprising software for enabling visual components representing metrics from different systems, applications or hardware to be shown on a screen display, wherein an administrator, programmer or like person can assign a metric to the visual components displayed.

13. A program as claimed in claim 1 further comprising software wherein an alarm can be set to trigger in response to a particular metric reaching a threshold level.

14. A program as claimed in claim 13 further comprising software wherein a threshold level for said particular metric can be confirgured by the administrator, programmer or like person.

15. A program as claimed in claim 13 further comprising software wherein when the configured threshold level is reached an alarm can trigger a particular response including, but not limited to:
a) sending an email
b) executing a script or an application
c) displaying a pop-up message.

16. A program as claimed in claim 1 further comprising software for permitting a visual component to automatically correspond visually to the number of instances in the computer system.

17. A program as claimed in claim 1 further comprising software where an administrator, programmer or like person can copy and paste a visual component from one screen display to another screen display.

18. A program as claimed in claim 17 comprising software where an administrator can copy and paste a visual component from one screen display to another screen display, and automatically carry all instances in the paste to the another screen.

19. A program as claimed in claim 17 further comprising software that will carry an assigned metric for a respective visual component when an administrator, programmer or like person copies and pastes a visual component from one screen to another screen to permit the assigned metric to be with the visual component on the another screen.

20. A program as claimed in claim 1 comprising software for enabling an administrator, programmer or like person to tag multiple metrics allowing those tagged multiple metrics to hold the same metric attributes as each other.

21. A program as claimed in claim 20, comprising software where an alarm can be set to trigger in response to a metric reaching a threshold level, and wherein tagged multiple metrics hold the same threshold level.

22. A program as claimed in claim 1 comprising software for enabling an administrator, programmer or like person to create a topology view screen display of an organisation, and to be able to create a drill down feature to permit drilling down from a topology view to a screen display of one or more visual components representing specific system, application, or hardware device information.

23. A program as claimed in claim 22 comprising software for enabling a hierarchical tree structure to be created depicting the topology view screen display down to the screen display representing specific system, application, or hardware device information, and to have an object assigned to each node thereof that will depict a current state of health of a node to which the object is assigned, thereby permitting a snapshot view from the hierarchical tree structure that will permit a visual determination of an unhealthy node to be quickly ascertained and the need to drill down through that node to a screen display of the one or more visual components representing specific system, application, or hardware device information, to view a metric that may be the reason for the unhealthy node.

24. A method of providing a snapshot view of the performance of a computer system or of an application or of hardware associated with a computer system, hereinafter referred to as monitored environment, comprising, loading a computer monitoring program into the computer system,
said computer program being for monitoring the performance or state of a computer system or of an application operable within said computer system or of a computer hardware device in a computer system,
the computer program comprising software configured to permit a screen display of one or more visual components representing specific system, application, or hardware device information chosen by an administrator, programmer or like person,
said software having processing that permits the assigning of a metric chosen by the administrator, programmer or like person to a visual component provided on the screen display,
thereby providing a user with a diagnostic snapshot view of the performance or state of one or more computer systems or of one or more applications or of one or more hardware devices,
using the program to design a screen display to show one or more visual components of the computer system, and to assign a respective metric to a visual component, and then running the program in a monitoring mode where a snapshot view can be provided of the monitored environment.

25. A method as claimed in claim 24 comprising customising the position of a chosen visual component of the screen display.

26. A method as claimed in claim 25 comprising customising the scale and/or height and/or width of a chosen visual component of the screen display.

27. A method as claimed in claim 24 comprising designing a screen display to be a node of a hierarchical tree structure of the monitored environment.

28. A method as claimed in claim 27 comprising designing multiple nodes of the hierarchical tree structure each with separate screen displays, and using the hierarchical tree structure to drill-down into a more specific screen display.

29. A method as claimed in claim 24, comprising designing screen displays of multiple interconnected computer systems using chosen visual components for each system and assigning a respective metric to chosen visual components, each interconnector computer system being represented by a node of a hierarchical tree structure.

30. A method as claimed in claim 24, comprising displaying on a screen display a visual depiction of the health of multiple metrics.

31. A method as claimed in claim 24 comprising drawing attention to a least healthy metric shown on a screen display by modifying a visual depiction of the visual component based on a health severity threshold of the metric.

32. A method as claimed in claim 24 comprising assigning a threshold level to a particular metric, and causing an alarm to trigger in response to the metric reaching the threshold level.

33. A method as claimed in claim 24 comprising creating a topology view screen display of an organisation, and providing a feature to permit drilling down from a topology view, to a screen display of one or more visual components representing specific system, application, or hardware device information of the monitored environment.

34. A method as claimed in claim 24 comprising creating a hierarchical tree structure to be created depicting the topology view screen display down to the screen display representing specific system, application, or hardware device information, and assigning an object to each node thereof to depict a current state of health of the node to which the object is assigned, thereby providing a snapshot view from the hierarchy tree structure that will permit a visual determination of an unhealthy node to be quickly ascertained and the need to drill down through that node to a screen display of the one or more visual components representing specific system, application, or hardware device information of the monitored environment, to view a metric that may be causing the reason for the unhealthy node.

35. A computer system loaded with a computer program;, said computer program being for monitoring the performance or state of a computer system or of an application operable within said computer system or of a computer hardware device in a computer system,
the computer program comprising software configured to permit a screen display of one or more visual components representing specific system, application, or hardware device information chosen by an administrator, programmer or like person,
said software having processing that permits the assigning of a metric chosen by the administrator, programmer or like person to a visual component provided on the screen display,
thereby providing a user with a diagnostic snapshot view of the performance or state of one or more computer systems or of one or more applications or of one or more hardware devices,
the computer system having a screen display designed by showing one or more visual components of the monitored environment with an assigned metric, the computer system having the computer program running in a monitoring mode and providing a snapshot view of the performance of the monitored environment.
